(19) United States
(12) Patent Application Publication
(10) Pub. No.: US 2011/0150161 A1
(43) Pub. Date: Jun. 23, 2011

(54) Method of stabilization and controlling of the nuclear ammunitions physical and mechanical parameters by means of usage "absorbing shutter" changing own aggregate state during of the initiation process

(76) Inventor: Grigory Kaganitsky, Montreal/Pierrefonds (CA)

(21) Appl. No.: 12/641,345

(22) Filed: Dec. 18, 2009

(51) Int. Cl. G21C 7/06

(52) U.S. Cl. 376/219; 376/914

(57) ABSTRACT

It is presented, the method of stabilization and controlling of nuclear devices' parameters by means of usage of “absorbing shutter”. This method is based on usage of neutron's absorbing substance as “absorbing shutter” that split and shield active parts of nuclear device and may carry out the controlled changing own aggregate state for starting of initiation's process. When its aggregate state is changed, “absorbing shutter” can vary mechanical and physical parameters of a nuclear device's active main body.

Prior to initiation, “absorbing shutter” holds the nuclear device into “below-critical configuration” and forms with parts of the nuclear device's active main body the monoblock that is not having significant hollow spaces. The hollow spaces' lacking gives to device mechanical properties of an incompressible solid body.

The changing of mechanical parameters of “absorbing shutter” in time of the initiation's process starting gives capability to transfer device from “below-critical configuration” to “above-critical configuration” by means of mechanical forcing to the nuclear device's active main body.

This transfer is carry out by removing “absorbing shutter” that has new aggregate state out of the active main body by means of the active main body mechanical deformation into more tight form.

(Above or below, with the purpose of the text simplification, the concept of “nuclear device” or “device” includes any ammunition which use for own function's realization the physical effect—“nuclear chain-reaction at achievement to the chain-reacting amount”)

(Above or below, with the purpose of the text simplification, under the term “absorbing shutter” be implied the neutron's absorbing substance that carry out controlled changing of own aggregate state and level of neutron's absorbing during of the initiation process of the nuclear device)

(Above or below, the concept of “above-critical configuration” includes such combination of weight, geometrical parameters and a physical phase of a charge at which the nuclear chain reaction starts spontaneously)

(Above or below, the concept “below-critical configuration” includes such combination of weight, geometrical parameters and a physical phase of a charge at which the nuclear chain reaction cannot be starting spontaneously)

(All dimensions of parts and devices and theirs geometrical mutual correlations which are given on the drawings attached at the patent application must not be understood as the specific features of the described method and devices. They serve for the demonstrative purposes)

The destination and the area of application of the method:
1. Designing of the deep penetration's nuclear ammunition;
2. Designing of the simplified, small-sized ammunitions such as “the howitzer configuration of initiation” with plutonium usage

### Prospective Users

Army—designing of special purposes' nuclear devices

The proposals, which are given into the patenting process:

There is possibility to use the “absorbing shutter” in nuclear devices for:
1. Controlling of transition's process from “below-critical configuration” to “above-critical configuration” of nuclear ammunition during initiation;
2. Making of nuclear ammunition that has, up to initiation's moment, the mechanical strength such as a mechanical strength of a monolithic solid body;
3. Making of nuclear ammunition for underground structures' breakdown;
4. Making of small-sized, simplified version of nuclear ammunition;
5. Making of small-sized “the howitzer configuration of initiation” nuclear devices by plutonium usage.

### APPLICATION OF PATENT

It is presented, the method of stabilization and controlling of nuclear devices' parameters by means of usage of “absorbing shutter”. This method is based on usage of neutron's absorbing substance as “absorbing shutter” that split and shield active parts of nuclear device and may carry out the controlled changing own aggregate state for starting of initiation's process. When its aggregate state is changed, “absorbing shutter” can vary mechanical and physical parameters of a nuclear device's active main body.

Prior to initiation, “absorbing shutter” holds the nuclear device into “below-critical configuration” and forms with parts of the nuclear device's active main body the monoblock that is not having significant hollow spaces. The hollow spaces' lacking gives to device mechanical properties of an incompressible solid body.

The changing of mechanical parameters of “absorbing shutter” in time of the initiation's process starting gives capability to transfer device from “below-critical configuration” to “above-critical configuration” by means of mechanical forcing to the nuclear device's active main body.

This transfer is carry out by removing “absorbing shutter” that has new aggregate state out of the active main body by means of the active main body mechanical deformation into more tight form.

<<Absorbing shutter>> carries out the following functions:
1. Prior to initiation's moment, it gives for the “nuclear device” the mechanical properties of an incompressible solid body;
2. After mechanical forcing started, it secures time delay, from moment of hit into target up to moment of forming “above-critical configuration”. The time delay takes place during time necessary for an aggregate state's changing of “absorbing shutter”.
3. Usage of “absorbing shutter” gives more steep a rising edge of the nuclear chain reaction as against of simple approaching of active parts.

### PROCESS DESCRIPTION

Prior to initiation's moment, “absorbing shutter” has the aggregate state that prevents approaching of active parts and, as result of that, changing of device's condition to “above-critical configuration” under influence of allowable physical and mechanical loads.

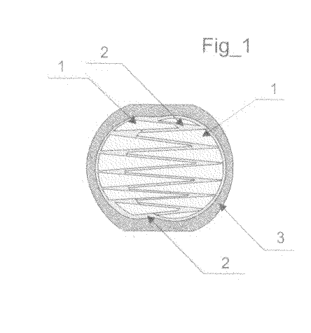

The device's active main body consists of active parts—1 divided by “absorbing shutter”—2. “Absorbing shutter” consist of a neutron's absorbing substance that is in the solid aggregate state. Active parts and “absorbing shutter” are covered by a porous casing—3. FIG. 1

The active main body and whole device prior to initiation's moment look like solid, high-stable body.

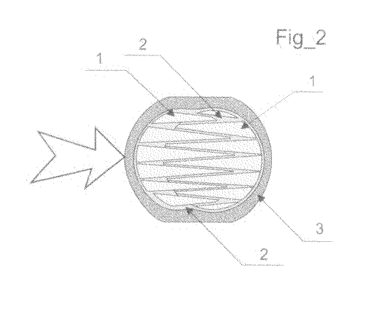

In first moment of initiation, the active main body is being subjected by mechanical forces and simultaneously “absorbing shutter” has starting of changing of own aggregate state under an external influence. As a result of that, “absorbing shutter” melts or vaporizes and can be forced out off active parts into a porous casing. FIG. 2

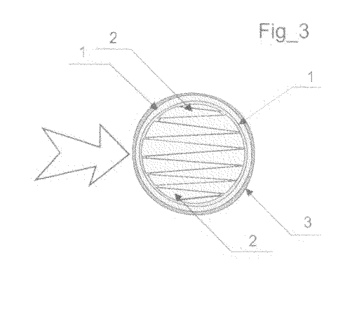

As a result of that, active parts are permitted to movement, level of neutron's absorbing ability of “absorbing shutter” is being decreased and active main body comes into “above-critical configuration”. FIG. 3

Nuclear reaction's rise rate depend both as of parts' approach velocity and as of ability changing of “absorbing shutter” to neutrons' absorbing during of the initiation process of the nuclear device.

In result of such imposition, at the equal starting conditions, nuclear reaction's rise rate of device which has “absorbing shutter” above than nuclear reaction's rise rate of devices using simple approaching or implosion.

In the capacity of the external influence onto “absorbing shutter” which initiates his aggregate state changes it can be heating liberation as a result of a plastic deformation of “absorbing shutter” and/or warming by means of an energy arrival from without.

Delay of the initiation start can be set by choice of an initial temperature of “absorbing shutter”.

Capacity of “absorbing shutter” to neutrons' absorbing in every one key moment is depend on mechanical and physical characteristic property of its material, a rise rate of its aggregate state changing and of speed of its squeezing-out from active main body. These parameters should be chosen depending on active parts' features of a device.

In specific cases, the first step of the initial changing of mechanical and physical characteristics of “absorbing shutter” can be induced by electric or magnetic method.

In specific cases, during of process of squeezing-out from the active main body, “absorbing shutter” can get through a few aggregate states and isotopes composition changing.

In specific cases, during of initiation's process, “absorbing shutter” can change own ability to the neutron's absorbing as and due to isotopes transmutation.

In specific cases, “absorbing shutter” can include substances, which use energy and neutrons emitting from the active main body for the initiation of fusion reaction and/or activating of substances boosting a damage effect. CL Examples of Innovation Usage

/All dimensions, materials and percentage ratios used in the description of hypothetical devices, which are described below, are taken from open Internet sources and they does not correspond a specific features of the given patent's innovation and they serve for the demonstrative purposes only./

### 1. Hypothetical Design of Deep Penetration's Nuclear Devices

### FIG. 6

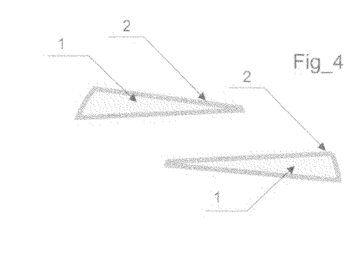

Active main body of the device is spheroid FIG. 4 consisting of separate, wedge-like elements of ²³⁵U—1, each of which has a case—2 that is formed by the deuteride of alloy of ⁶Li and ²³⁸U. This case works as “absorbing shutter”. Melting temperature of this deuteride is approximate 600° C.

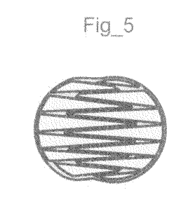

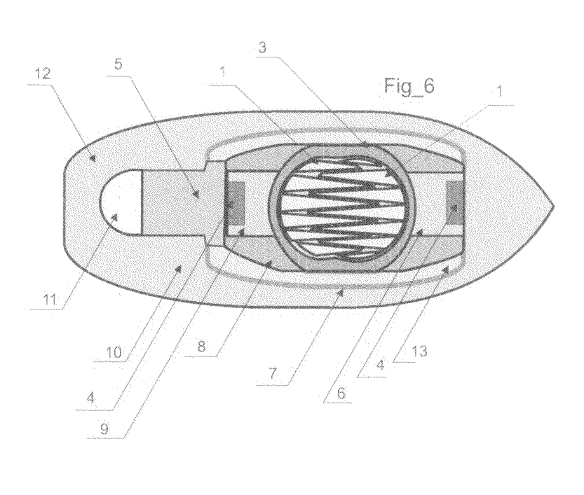

This layered spheroid by heat treatment usage is modified into the uniform solid body, which is having channels for a passing of a cooling agent, and this spheroid, prior to the initiation's moment, is being in “below-critical configuration”. FIG. 5

The spheroid is covered by a porous case—3 that is made by means of usage of ²³⁵U of the high enrichment that is ligation to plasticize. This case works as collector of squeezed out “absorbing shutter”.

For preventing of an untimely deformation, a porous case is filled by a substance having a low temperature of vaporization or sublimation. During initiation process, this substance is being removed and replaced by “absorbing shutter” squeezed out of main body.

The active main body consisting of the porous case and the spheroid is located between of matrix and puncheon—6, 9 which look like cylinders made by means of usage the deuteride of alloy of ²³⁵U and ⁶Li. Each of cylinders, in one side, comprises tablet of ²³⁹PU—4, being in “below-critical configuration” and “D” phase.

Cylinders are located inside of the directing barrels—8, which consist of ²³⁵U having approximately 50-60% of enrichment. All module—1, 2, 4, 6, 8, 9 is covered by case-resonator—13 that consist of ²³⁵U having approximately 40% of enrichment.

The case-resonator is covered by neutron reflector—7.

The massive piston-tup—5 thrusts to the one side of the module and has an auxiliary charge of chemical explosive—11.

Whole device is located in the case of high mechanical strength—12 and cooled up to the moment of penetration's beginning to a target by an external device.

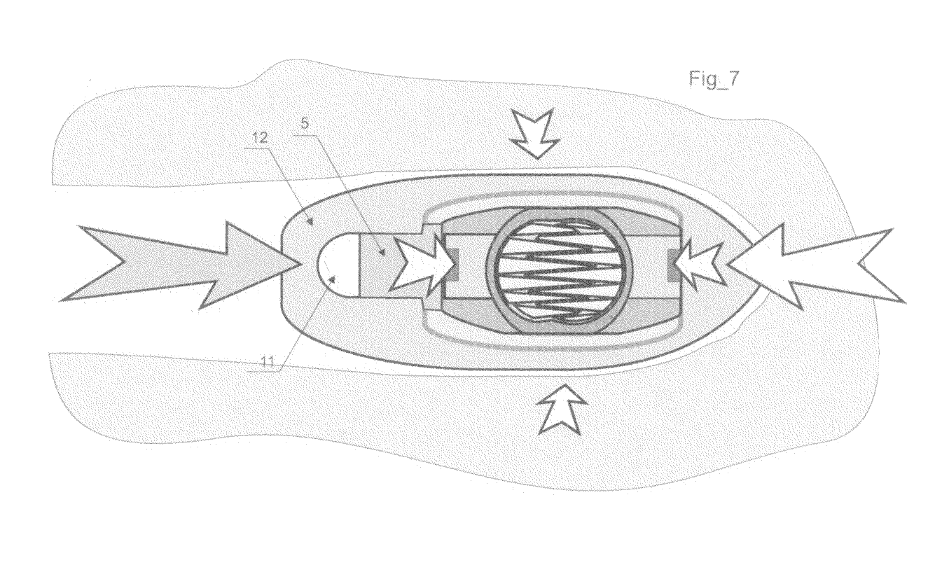

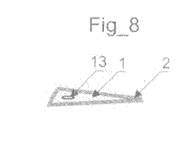

After a target is hit, device FIG. 7 that moves with speed 6-10 MAX penetrates into environment of target; produces in it a penetrating channel and is being decelerated.

Under the decelerating forces, deformations of the module's parts are started. Along process of deformation, under of the applying forces; the tablets—4, FIG. 6 is transformed into “A” phase and get close to “above-critical configuration”; the cases—2, FIG. 4, which work as “absorbing shutter” be melted and pressed-out into the porous case. As result of that, the active main body is being transformed into “above-critical configuration” and primary initiation of device is being carried out.

### 2. Hypothetical Design of Simplified Plutonium Devices

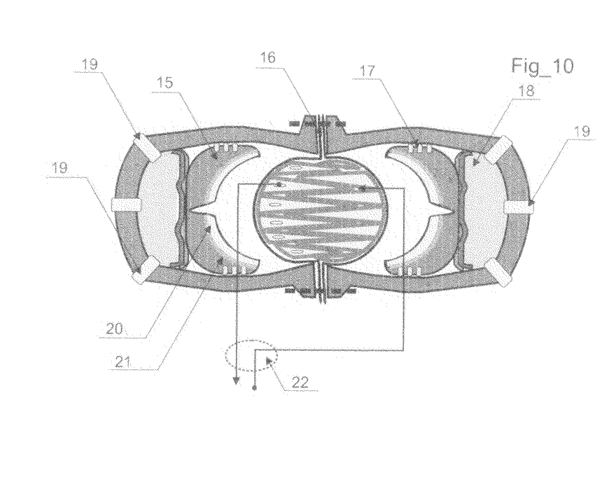

### FIG. 10

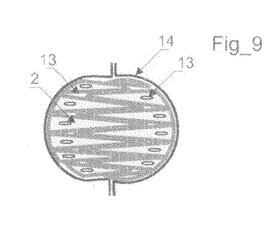

The active main body of the device is spheroid FIG. 9 consisting of separate, wedge-like elements of ²³⁹PU—1 ligation by gallium, each of which has refrigerant channels—13 and cast or built-up case—2 that is formed by means of a 6Li suspension in the deuterium modified paraffin.

This case works as “absorbing shutter”. Its melting temperature is approximate 50-60° C. The spheroid is covered by perforated jacket—14.

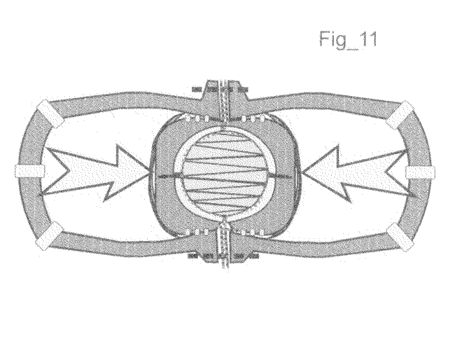

The device FIG. 10, FIG. 11 is designed as the active main body FIG. 9 that is located in cross of common symmetrical axes inside of the case of high mechanical strength—16 and it is cooled up to the moment of initiation by an external device—22.

Inside the case, the active main body is located between two blocks looking like the multiple-die of ²³⁸U—15 each of which have on its inner face two layers: the first of a neutron reflector—21 and the second of spongy ²³⁵uranium carbide—20 of the high enrichment. This spongy case, into the initiation's moment, is working as the collector of “absorbing shutter”.

Each of the multiple-die blocks is organized by a helix-consolidator—17. Between the high mechanical strength case and the multiple-die blocks have chemical charges—18. They triggers—19 are located on each ends of the strength case.

1. The method of controlling and changing of nuclear ammunitions' parameters during the initiation's process by means of usage of “absorbing shutter” that changes own aggregate state and can be pressed-out of the ammunitions' active main body;

2. The “absorbing shutter” designed as casing on each of fissionable parts of nuclear ammunitions' active main body and which prevents starting of nuclear reaction by neutrons' absorbing only until the initiation's moment;

3. Usage as “absorbing shutter” a neutron absorber that has ability, under an external action and/or during initiation's process, to change own physicochemical characteristic properties, as example—aggregate state; isotopes composition; level of neutrons' absorbing et cetera;

4. Usage as “absorbing shutter” a neutron absorber that has ability during initiation's process, after of own an aggregate state changing, be pressed-out from the devices' active main body;

5. During initiation's process, usage of pressing-out of “absorbing shutter” out of the reaction's zone for obtaining more steep a rising edge of nuclear chain reaction;

6. Usage “absorbing shutter” and given method for designing of the active main body of deep penetrations' nuclear ammunitions that has, before of the initiation's moment, mechanical strength such as a mechanical strength of a monolithic solid body and receiving increased level of permissible geometrical deformation of active main body in comparison with earlier used methods and designs;

7. Usage “absorbing shutter” and given method for making of plutonium the nuclear ammunitions that have “the howitzer configuration of initiation”.
